(19) United States
(12) Patent Application Publication
(10) Pub. No.: US 2026/0356134 A1
(43) Pub. Date: Nov. 12, 2026

(54) Vehicle Leveling Systems and Methods

(71) Applicant: West Desert LLC, West Valley City, UT (US)

(72) Inventors: Andrew Markus, West Jordan, UT (US); Dallin Clawson, West Valley City, UT (US)

(73) Assignee: West Desert LLC, West Valley City, UT (US)

(21) Appl. No.: 19/671,052

(22) Filed: May 7, 2026

Related U.S. Application Data
(60) Provisional application No. 63/801,521, filed on May 7, 2025.

(51) Int. Cl. B60C 23/00

(52) U.S. Cl. CPC B60C 23/002

(57) ABSTRACT

A vehicle leveling system and method are disclosed. The system includes a manifold in pneumatic communication with each tire of a vehicle, comprising a plurality of tire valves controlling gas flow between the manifold and each tire, an atmosphere valve controlling gas flow between the manifold and ambient atmosphere, and optionally a source of compressed gas connected via a compressed gas valve. At least one sensor is configured to detect the pitch and roll of the vehicle. A processor receives data from the sensor and operates the tire valves and atmosphere valve to deflate or inflate one or more tires to adjust the pitch and/or roll of the vehicle to within preselected parameters.

### TECHNICAL FIELD

The present disclosure relates to systems and methods for leveling a stationary vehicle. More specifically, it relates to systems and methods of leveling a stationary vehicle by adjusting tire pressures.

### REFERENCES

This application claims priority to U.S. Provisional Patent Application No. 63/801,521 filed May 7, 2025, entitled "VEHICLE LEVELING SYSTEMS AND METHODS, the entire disclosure of which is incorporated herein by reference in its entirety.

### BACKGROUND

Outdoor and camping enthusiasts often stay and sleep in or on their vehicles. If the vehicle is not parked on a level surface, often because one is not available in remote camping areas, they may be forced to sleep on an uncomfortably non-level surface. This can cause sleeping bags or other bedding to shift or move downhill overnight. To achieve a more level surface, people may try to place objects, such as boards, rocks, logs, and the like, under one or more tires to raise them. This solution may improve the situation but is inaccurate and unlikely to achieve a level sleep surface. It is also a time-consuming and frustrating process of trial and error requiring repeated movement of the vehicle on and off various objects.

### SUMMARY

In accordance with one embodiment, a system for leveling a stationary vehicle is provided, comprising a manifold attached to each tire of the vehicle, the manifold including a plurality of pneumatic connections comprising an outlet and a connection to each tire, a plurality of tire valves each controlling flow between the manifold and a tire, and an atmosphere valve controlling flow between the manifold and the outlet to the atmosphere. The system further comprises at least one sensor configured to detect a pitch and a roll of the vehicle, and a processor operatively coupled to the at least one sensor and configured to open and close the plurality of tire valves and the atmosphere valve using data from the at least one sensor. The processor contains non-volatile, computer-readable medium instructions to determine if the pitch and/or roll of the vehicle are within preselected parameters, and if not, operate at least one tire valve to deflate one or more tires to adjust the pitch and/or roll of the vehicle.

In accordance with another embodiment, the manifold is adapted to attach to a source of compressed gas via a compressed gas valve.

In accordance with another embodiment, the processor is programmed to use one or more of the tire valves, the source of compressed gas, the compressed gas valve, and the manifold to inflate the tire.

In accordance with another embodiment, the manifold comprises an ambient valve to vent to ambient air and a compressed gas valve to open the tire to the source of compressed gas.

In accordance with another embodiment, the manifold further comprises a pressure sensor in fluid communication with the tires whereby the processor monitors the pressure in each tire.

In accordance with another embodiment, the processor is programmed to keep the pressure in each tire within a prescribed pressure range.

In accordance with another embodiment, the processor is programmed to bring a pressure in the tires to a predetermined pressure prior to the vehicle being moved again.

In accordance with another embodiment, the at least one sensor comprises at least one accelerometer.

In accordance with another embodiment, a method of leveling a vehicle is provided, comprising providing at least one sensor configured to detect a pitch and roll of the vehicle, providing a manifold comprising a plurality of pneumatic connections to the manifold including an outlet to the atmosphere and a connection to each tire, a plurality of tire valves each controlling flow between the manifold and a tire, and an atmosphere valve controlling flow between the manifold and the outlet to the atmosphere, and providing a processor operatively coupled to the at least one sensor and configured to operate the atmosphere valve and the plurality of tire valves. The processor contains non-volatile, computer-readable medium instructions to determine if the pitch and/or roll of the vehicle are within preselected parameters, and if the pitch and/or roll are outside the preselected parameters, operating the at least one valve to deflate one or more tires to adjust the pitch and roll of the vehicle.

In accordance with another embodiment, the method further comprises providing a source of compressed gas in fluid communication with the manifold via a compressed gas valve.

In accordance with another embodiment, the processor is programmed to use one or more of the tire valves, the source of compressed gas, the compressed gas valve, and the manifold to inflate one or more tires to adjust the pitch and/or roll of the vehicle.

In accordance with another embodiment, the manifold further comprises a valve to open the tire to the source of compressed gas.

In accordance with another embodiment, the method further comprises providing a pressure sensor in fluid communication with the tire whereby the processor monitors the pressure in each of the tires.

In accordance with another embodiment, the processor is programmed to keep the pressure in each tire within a prescribed pressure range.

In accordance with another embodiment, the method further comprises measuring the pitch and/or roll of the vehicle, adjusting a pressure in one or more of the tires, and repeating the measuring and adjusting steps until the pitch and roll of the vehicle are within the parameters.

In accordance with another embodiment, the processor is programmed to inflate the tires to a selected pressure for driving.

In accordance with another embodiment, a system for leveling a stationary vehicle is provided, comprising at least one sensor configured to detect a pitch and a roll of the vehicle, and a plurality of tire inflation control devices each comprising a tire valve in fluid communication with a tire, an atmosphere valve in fluid communication with the atmosphere, and a tire pressure gauge in fluid communication with the tire valve. A processor is configured to receive data from the at least one sensor and to control the tire valves and the atmosphere valves, and contains non-volatile, computer-readable medium instructions to determine if the pitch and roll of the vehicle are within preselected parameters, and if not, operate at least one valve to deflate one or more tires to adjust the pitch and roll of the vehicle.

In accordance with another embodiment, each of the plurality of tire inflation control devices is adapted to attach to a source of compressed gas via a compressed gas valve.

In accordance with another embodiment, the processor is programmed to use one or more of the tire valves, the source of compressed gas, and the plurality of tire inflation control devices to inflate the tire.

In accordance with another embodiment, each of the plurality of tire inflation control devices comprises a valve to open the tire to the source of compressed gas.

Further aspects and embodiments are provided in the foregoing drawings, detailed description, and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a perspective view of an exemplary vehicle leveling system.

FIG. 2 is a schematic diagram illustrating exemplary pneumatic connections of the vehicle leveling system of FIG. 1.

FIG. 3 is a schematic diagram illustrating exemplary electrical and control connections of the vehicle leveling system of FIG. 1.

FIG. 4 is a schematic diagram illustrating an exemplary inflation system of the vehicle leveling system of FIG. 1.

FIG. 5 is a schematic diagram illustrating exemplary electrical connections for power and control of the vehicle leveling system of FIG. 1.

FIG. 6 is a flowchart illustrating a first portion of an exemplary method for leveling a vehicle using the disclosed system.

FIG. 7 is a flowchart illustrating a second portion of the exemplary method for leveling a vehicle using the disclosed system.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

As used herein, “and/or” includes any and all combinations of one or more of the associated listed items.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

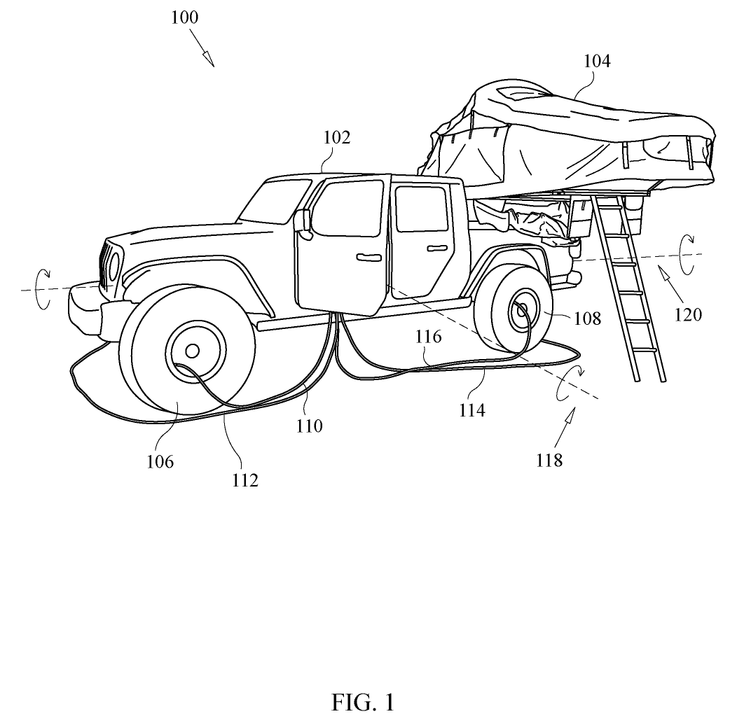

As used herein, “level” is meant to refer to the horizontal plane (i.e., perpendicular to the force of earth’s gravity) or the position of a surface or object relative to the horizontal. In discussing level, the terms “pitch” and “roll”, as they are commonly used (see FIG. 1), may be used to describe turns and deviations from the horizontal plane and adjustments made to the orientation of a vehicle. Pitch describes rotation around axis 118 in FIG. 1. Roll describes rotation around axis 120 in FIG. 1.

As used herein “data” refers to information. Data may be used to refer generically to modes of storing and/or conveying information. Accordingly, data may refer to textual entries in a table of a database. Data may refer to alphanumeric characters stored in a database. Data may refer to machine-readable code. Data may refer to images. Data may refer to audio. Data may refer to, more broadly, a sequence of one or more symbols. The symbols may be binary. Data may refer to a machine state that is computer readable. Data may refer to human-readable text.

As used herein, the term “data connection” and similar terms are meant to refer to any wired or wireless means of transmitting analog or digital data and a data connection may refer to a connection within a vehicle or with devices outside the vehicle.

As used herein “same” means sharing all features and “similar” means sharing a substantial number of features or sharing materially important features even if a substantial number of features are not shared. As used herein “may” should be interpreted in a permissive sense and should not be interpreted in an indefinite sense. Additionally, use of “is” regarding examples, elements, and/or features should be interpreted to be definite only regarding a specific example and should not be interpreted as definite regarding every example. Furthermore, references to “the disclosure” and/or “this disclosure” refer to the entirety of the writings of this document and the entirety of the accompanying illustrations, which extends to all the writings of each subsection of this document, including the Title, Background, Brief description of the Drawings, Detailed Description, Claims, Abstract, and any other document and/or resource incorporated herein by reference.

As used herein, the term “sensor” is meant to refer to any device for detecting and/or measuring a property of a person or substance regardless of how that property is detected or measured, including the absence of a target molecule or characteristic.

Various aspects of the systems described herein may be referred to as “data.” Data may be used to refer generically to modes of storing and/or conveying information. Accordingly, data may refer to textual entries in a table of a database. Data may refer to alphanumeric characters stored in a database. Data may refer to machine-readable code. Data may refer to, more broadly, a sequence of one or more symbols. The symbols may be binary. Data may refer to a machine state that is computer readable. Data may refer to human-readable text.

A vehicle leveling system as disclosed herein will become better understood through a review of the following detailed description in conjunction with the figures. The detailed description and figures merely provide examples of the various embodiments of vehicle leveling systems. Many variations are contemplated for different applications and design considerations; however, for the sake of brevity and clarity, all the contemplated variations may not be individually described in the following detailed description. Those skilled in the art will understand how the disclosed examples may be varied, modified, and altered and not depart in substance from the scope of the examples described herein.

Conventional attempts to solve this problem typically involve ad hoc solutions involving repurposing some object (e.g., rock, board, block, brick, log, etc.) to elevate individual tires. These solutions may provide some improvement for the problem of a non-level vehicle platform, but are rarely, if ever, fully successful.

Implementations of the disclosed vehicle leveling systems and methods may address some or all the problems described above. A vehicle leveling system may include a manifold connectable to each of a vehicle’s tires with valves allowing a tire to be deflated and a pressure sensor to monitor tire pressure. A system also includes one or more sensors for measuring the pitch and/or roll of a vehicle. Data from the sensors is used by a controller or processor to lower and/or raise pressure in the tires to achieve vehicle levelness. A system may also include a source of compressed or pressurized gas to inflate a tire.

In various embodiments, a vehicle leveling system includes one or more sensors (e.g., accelerometers) that detect a pitch and/or roll of the vehicle. The sensors are in communication with a controller and/or processor that receives data from the sensors. The sensors may be an original and integral part of the vehicle or may be an addon that is part of the leveling system. The system also includes a manifold operated by the processor to deflate and/or inflate one or more of the vehicle’s tires, e.g., the driver’s front (DF), passenger’s front (PF), passenger’s rear (PR), and driver’s rear (DR) for a typical vehicle having four tires (the system may be adapted for vehicles with more than 4 tires). The processor receives this data and processes it to determine which tire or tires to deflate or inflate to adjust the level of the vehicle.

FIG. 1 represents an exemplary vehicle leveling system 100. In the exemplary embodiment, a rooftop tent 104 is positioned atop a vehicle 102. The vehicle 102 includes a driver’s front (DF) tire 106, a driver’s rear (DR) tire 108, a passenger’s front (PF) tire (not shown), and a passenger’s rear (PR) tire (not shown). A DF tire connection 110 extends between a manifold (not shown) and the DF tire 106, a PF tire connection 112 extends between the manifold and the PF tire, a PR tire connection 114 extends between the manifold and the PR tire, and a DR tire connection 116 extends between the manifold and the DR tire 108.

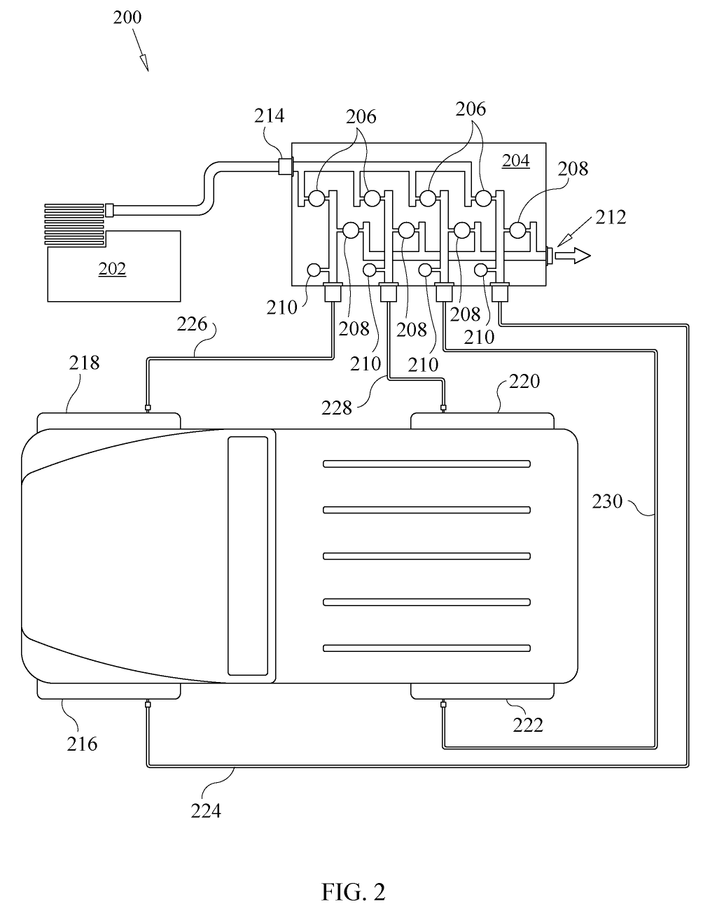

FIG. 2 illustrates an exemplary vehicle leveling system 200. FIG. 2 is a schematic representation of the pneumatic connections for an implementation of the system. A manifold 204 is connected to a source of compressed gas 202 (e.g., an air compressor, compressed air tank) via an inlet valve 214 and further includes an atmosphere valve 212 which vents to the ambient atmosphere external to the system 200. The inlet valve 214 controls flow through the manifold 204 to each tire connection described below. The manifold 204 also includes pneumatic connections for each tire of a vehicle (DF tire 216, PF tire 218, PR tire 220, and DR tire 222), including a DF tire connection 224, a PF tire connection 226, a PR tire connection 228, and a DR tire connection 230. A processor (e.g., CPU; not shown) controls each of the valves 214, 212 to control air flow into or out of each tire. The manifold 204 is further connected to one or more pressure sensors 210 that is/are used to monitor pressure in the manifold 204. The manifold 204 also includes one or more tire valves 206 working in connection with the source of compressed gas 202 to inflate one or more tires 216-222, in addition to one or more atmosphere valves 208 which operate to help deflate one or more of the tires 216-222 by releasing gas through the atmosphere valve 212. This may be part of the leveling process or to reinflate the tires to a proper level prior to the vehicle being driven.

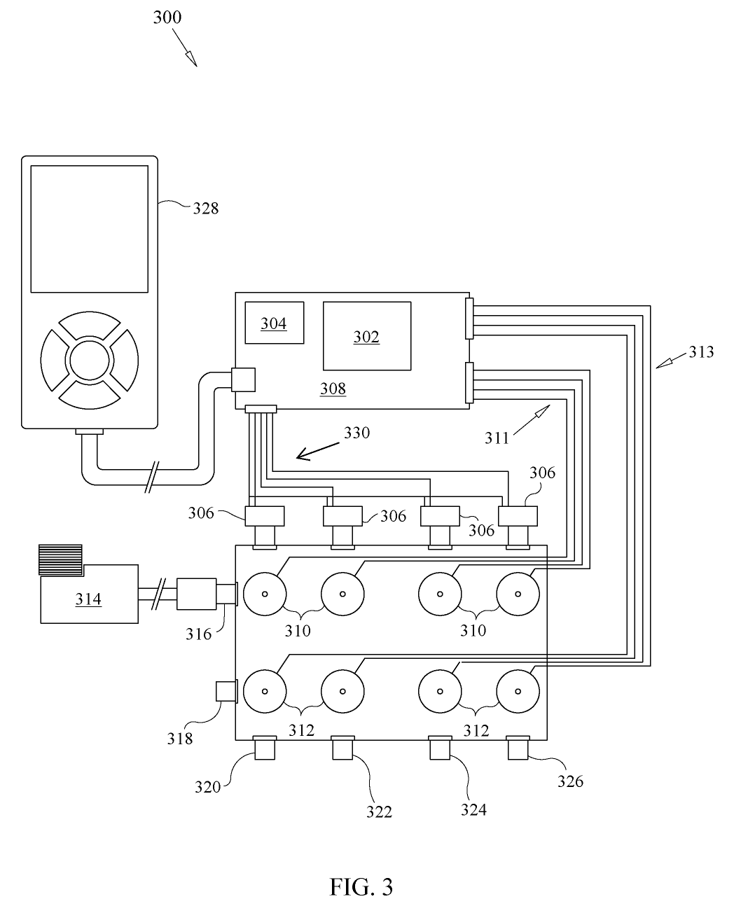

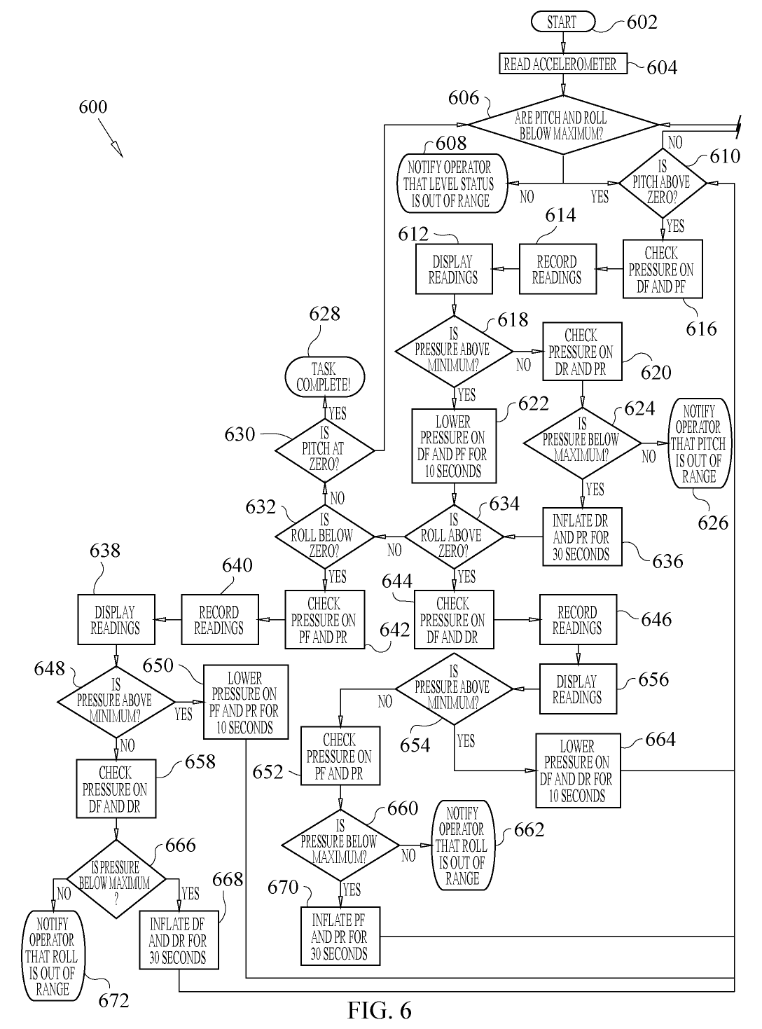

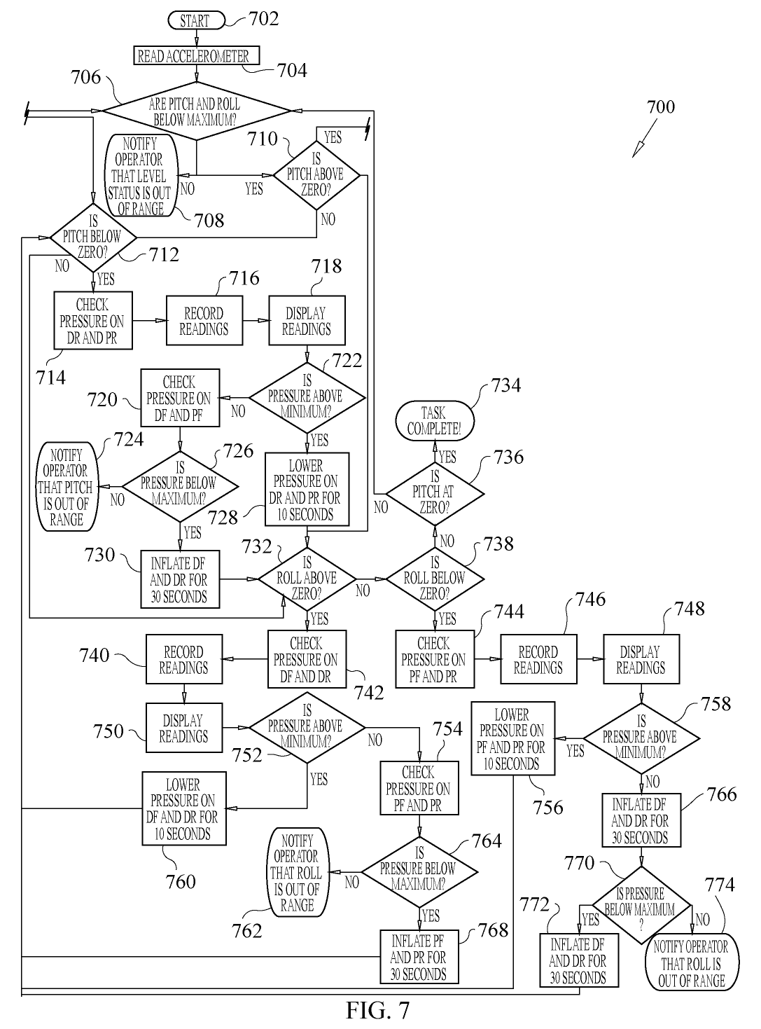

Referring to FIG. 3 is a schematic illustration of electrical connections in an implementation of the disclosed systems. The processor 302 (e.g., CPU/controller) receives data from one or more level sensors 304 (e.g., accelerometers) in or on a vehicle. The processor 302 also receives data from pressure sensors 306 via connections 330 in fluid communication with each of the vehicle’s tires (DF tire 320, PF tire 322, DR tire 324, and PR tire 326). Connections 311 connect the manifold 308 to the tire valves 310, and connections 313 connect the manifold 308 to the atmosphere valves 312. Each connection 311 and 313 helps control gas flow to and from one or more of the tires 320-326. The processor 302 also is connected to a compressed gas valve 316 to control gas flow from a source of compressed gas 314 into the manifold 308, and to an ambient air outlet 318 to vent gas to the atmosphere. Using data from the one or more level sensors 304, the processor 302 determines the pitch and roll and compares them to preselected parameters. If the pitch and/or roll is outside of the preselected parameters, the processor 302 actuates one or more of the tire valves 310 and/or atmosphere valves 312 to deflate or inflate one or more of the tires 320-326 (see FIGS. 6-7).The system may include a remote 328 for a user to control the system 300.

In an implementation, the processor 302 is programmed to monitor the pressure in each tire 320-326 via the pressure sensors 306 and to keep the pressure in each tire within a prescribed pressure range. If the pressure in one or more of the tires 320-326 falls outside the prescribed pressure range during the leveling process, the processor 302 actuates one or more of the tire valves 310 and/or atmosphere valves 312 to inflate or deflate the affected tire(s) until the pressure returns within the prescribed pressure range.

Optionally, referring to FIG. 3, the vehicle leveling system may replace the manifold with a plurality of individual tire inflation control devices, for example, one for each tire 320-326, with each comprising a tire valve 310 in fluid communication with a tire, an atmosphere valve 312 in fluid communication with the atmosphere, and a tire pressure gauge 306 in fluid communication with the tire valve 310. Each tire inflation control device may further attach to a source of compressed gas 314 via a compressed gas valve 316 to enable inflation of one or more tires 320-326 in addition to deflation. In this example embodiment, the processor 302 is configured to receive data from the at least one sensor 304 configured to detect pitch and roll of the vehicle, and to control the tire valves 310 and atmosphere valves 312 of each tire inflation control device. The processor 302 contains non-volatile, computer-readable medium instructions to process data from the at least one sensor 304 and determine if the pitch and roll of the vehicle are within preselected parameters, and if the pitch and/or roll are outside the parameters, operate at least one tire valve 310 or atmosphere valve 312 to deflate one or more tires to adjust the pitch and roll of the vehicle. The processor 302 may further be programmed to use one or more of the tire valves 310, the source of compressed gas 314, the compressed gas valve 316, and the tire inflation control devices to inflate one or more tires to adjust the pitch and/or roll of the vehicle.

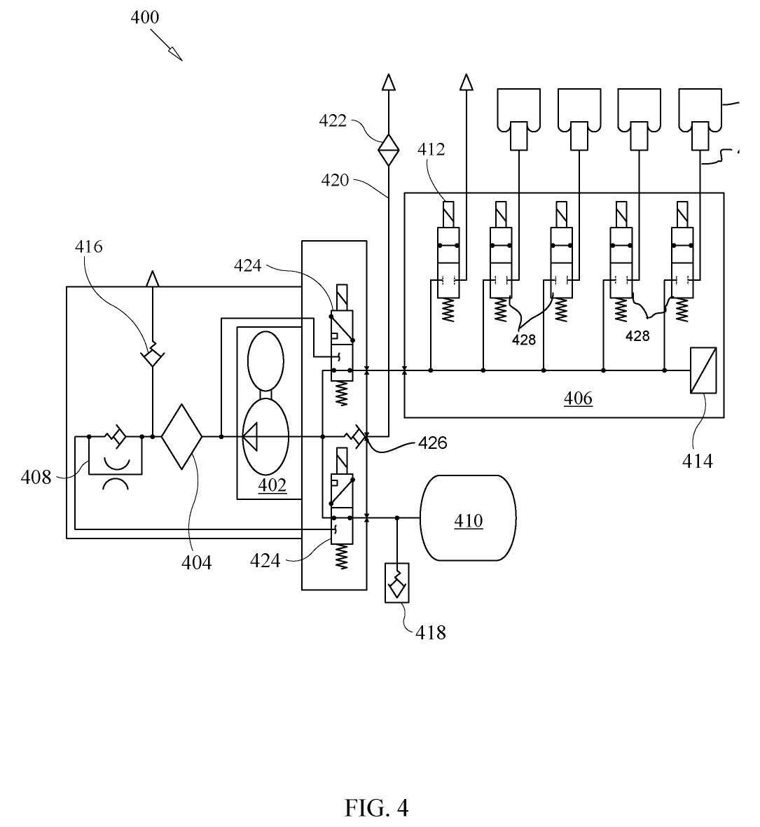

Referring now to FIG. 4, a vehicle leveling system may include an inflation system 400 providing an air/gas compressor 402 in pneumatic communication with an air dryer 404 (to reduce introduction of humidity into the system 400, manifold 406, and/or tires 432), a check valve 408, a compressed air/gas reservoir 410, an ambient valve 412, a pressure sensor 414, a pressure relief valve 416, a system filling valve 418 controlling flow to or from the reservoir 410, and an inlet hose 420 including an air filter 422 as an air supply to the compressor 402. The inlet hose 420 is connected to the compressor 402 via valve 426. The system 400 also includes two reversing valves 424 that help regulate flow into and/or out of the manifold 406 and the reservoir 410. Further, the system 400 includes one or more tire valves 428 which connect to one or more tires 432 via one or more connections 430.

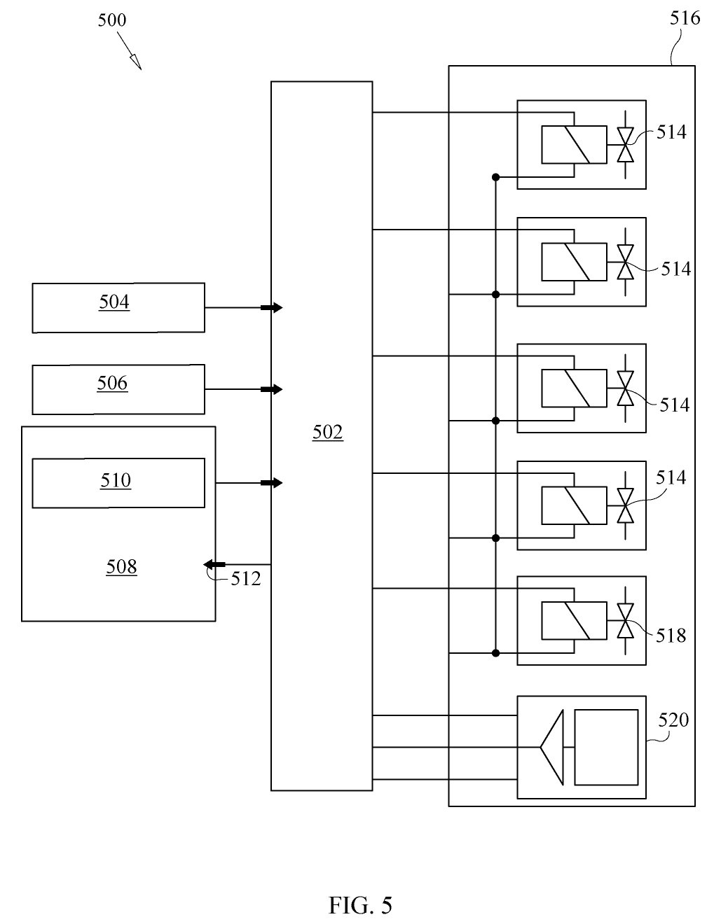

FIG. 5 is a schematic depiction of the electrical connections system 500 for power and/or control of system components. The connections may be wired or wireless depending on their purpose or use. A processor 502 (e.g., controller/control unit) is connected to a power source 504 (e.g., vehicle power supply), vehicle level sensors 506 (e.g., accelerometers), and to a user interface device 508. The processor 502 receives user inputs 510 (e.g., information, instructions, etc.) from the interface device 508 and sends feedback 512 and/or other information to the user interface device 508. The processor 502 is also in electronic connection for power and/or data with the tire valves 514 in a solenoid valve block 516 and a pressure sensor 520. An atmosphere valve 518 is also included in the solenoid valve block 516 and provides a fluid connection from the solenoid valve block 516 to the ambient atmosphere.

The processor 502 processes data from the vehicle level sensors 506 to determine the pitch and/or roll of the vehicle. The processor 502 includes a non-volatile computer readable medium with programming to adjust the pressure in the tires (e.g., reduce the pressure via the tire valves 514 and the atmosphere valve 518 to release gas from the tires) to change the pitch and/or roll of the vehicle (e.g., the algorithm in FIGS. 6-7). The processor 502 uses the pitch and roll data to calculate changes to be made to tire pressure(s). As the tires are typically fully inflated at the start of the process, pressure changes most frequently entail lowering tire pressure to bring the pressure in the tires to a predetermined pressure prior to the vehicle being moved again.

FIG. 6 illustrates an exemplary method 600 for leveling a vehicle using the disclosed systems. The method 600 begins at step 602 then involves reading an accelerometer at step 604 to determine the pitch and roll of the vehicle. At decision step 606, the processor determines whether the pitch and roll are below a maximum threshold. If the pitch and/or roll are not below the maximum threshold, the processor notifies the operator at step 608 that the level status is out of range, and the method ends. If the pitch and roll are below the maximum threshold, the method proceeds to decision step 610, where the processor determines whether the pitch is above zero. If the pitch is not above zero, the method proceeds to decision step 712 (see FIG. 7), where the processor determines whether the pitch is below zero then proceeds through the method 700 of FIG. 7.

Continuing with FIG. 6, if the pitch is above zero, the processor checks the pressure on the front tires (PF and DF) at step 616, records the readings at step 614, and displays the readings at step 612. Then, the processor determines whether the pressure is above minimum at step 618. If the pressure is not above minimum, the processor will check the pressure on the rear tires (DR and PR) at step 620. From there, the processor determines if the pressure is below maximum at step 624. If the pressure is not below maximum, the processor notifies the operator at step 626 that the pitch is out of range. If the pressure is below maximum, the processor inflates the rear tires (PR and DR) for 30 seconds at step 636. Subsequently, at step 634 the processor determines if the roll is above zero. If the roll is above zero, the processor checks the pressure on the DF and DR tires at step 644, then records readings at step 646, displays the readings at step 656, then determines if the pressure is above minimum at step 654. If the pressure is above minimum, the processor lowers the pressure on the DF and DR tires for 10 seconds at step 664, then the method proceeds back to the processor determining if the pitch is above zero at step 610. If the pressure is not above minimum at step 654, the processor checks the pressure on the PF and PR tires at step 652 then determines if the pressure is below maximum at step 660. If the pressure is not below maximum at step 660, the processor notifies the operator that the roll is out of range at step 662. If the pressure is below the maximum at step 660, the processor inflates the PF and PR tires for 30 seconds at step 670, then the method proceeds to step 610.

If the pressure is above minimum at step 618, the processor lowers the pressure on the DF and PF tires for 10 seconds at step 622, then determines if the roll is above zero at step 634.

Continuing with step 634, if the processor determines that the roll is not above zero, the processor next determines if the roll is below zero at step 632. If the roll is not below zero, the processor determines if the pitch is at zero at step 630. If the pitch is at zero, the task completes at step 628. If the pitch is not at zero, the method continues to step 606. Returning to step 632, if the pitch is below zero, the processor checks the pressure on the PF and PR tires at step 642, then records the readings at step 640, displays the readings at step 638, then determines if the pressure is above minimum at step 648. If the pressure is above minimum, the processor lowers the pressure on the PF and PR tires for 10 seconds at step 650 then the method returns to step 610. If the pressure is not above minimum, the processor checks the pressure on the DF and DR tires at step 658, then determines if the pressure is below maximum at step 666. If the pressure is not below maximum the processor notifies the operator that the roll is out of range at step 672, but if the pressure is below maximum the processor inflates the DR and DF tires for 30 seconds at step 668 then the method returns to step 610

If the pressure is not above minimum at step 648, the processor checks the pressure on the DF and DR tires at step 658, then determines if the pressure is below maximum at step 666. If the pressure is not below maximum, the processor notifies the operator that the roll is out of range at step 672, but if the pressure is below maximum, the processor inflates the DF and DR tires for 30 seconds at step 668 then the method returns to step 610.

FIG. 7 illustrates an exemplary method 700 for leveling a vehicle using the disclosed systems. The method 700 begins at step 702 then involves reading an accelerometer at step 704 to determine the pitch and roll of the vehicle. At decision step 706, the processor determines whether the pitch and roll are below a maximum threshold. If the pitch and/or roll are not below the maximum threshold, the processor notifies the operator at step 708 that the level status is out of range, and the method ends. If the pitch and roll are below the maximum threshold, the method proceeds to decision step 710, where the processor determines whether the pitch is above zero. If the pitch is above zero, the method proceeds to decision step 616 (see FIG. 6), where the processor checks the pressure on the PF and DF tires then proceeds through the method 600 of FIG. 6.

Continuing with FIG. 7, if the pitch is not above zero, the processor determines whether the pitch is below zero at step 712. If the pitch is not below zero, the method returns to step 710. If the pitch is below zero, the processor checks the pressure on the DR and PR tires at step 714, records the readings at step 716, displays the readings at step 718, then determines if the pressure is above minimum at step 722. If the pressure is above minimum at step 722, the processor lowers the pressure on the DR and PR tires for 10 seconds step 728. If the pressure is not above the minimum at step 722, the processor checks the pressure on the DF and PF tires at step 720. From step 720, the processor determines if the pressure is below maximum at step 726. If the pressure is not below maximum, the processor notifies operator that pitch is out of range at step 724 If pressure is below maximum at step 726, the processor inflates the DF and DR tires for 30 seconds at step 730 then determines if roll is above zero at step 732.

After step 728, the processor determines if the roll is above zero at step 732. If it is not, the processor determines if the roll is below zero at step 738. If the roll is not below zero, the processor determines if the pitch is at zero at step 736. If the pitch is at zero, the task completes at step 734. If the pitch is not at zero, the method returns to step 706. If the roll is below zero at step 738, the processor checks pressure on the PF and PR tires at step 744, records the readings at step 746 displays the readings at step 748, then determines if the pressure is above minimum at step 758. If the pressure is aove minimum, the processor lowers pressure on the PF and PR tires for 10 seconds at step 756 and the method returns to step 712. If pressure is not above minimum at step 758, the processor inflates the DF and DR tires for 30 seconds at step 766, then determines if pressure is below maximum at step 770. If pressure is below maximum, the processor inflates the DF and DR tires for 30 seconds at step 772 then the method returns to step 712. If the pressure is not below maximum at step 770, the processor notifies the operator that the roll is out of range at step 774 and the method ends.

If the roll is above zero at step 732, the processor checks pressure on the DF and DR tires at step 742 then records the readings at step 740. Next, the processor displays the readings at step 750 then determines if the pressure is above minimum at step 752. If the pressure is above minimum, the processor lowers the pressure on the DF and DR tires for 10 seconds at step 760 then the method returns to step 712.

Returning to step 752, if the pressure is not above minimum, the processor hecks the pressure on the PF and PR tires at step 754, then determines if the pressure is below maximum at step 764. If the pressure is not below maximum at step 764, the processor notifies operator that roll is out of range at step 762. If the pressure is below maximum at step 764, the processor inflates the PF and PR tires for 30 seconds at step 768 then the method returns to step 712.

For small changes in pressure, the relationship between pressure and height is nearly linear. However, at very low pressures, the ratio of height change to pressure change is at its greatest. The ratio of height change to pressure change declines as tire pressure increases. For this reason, in many cases one or more tires will be deflated to a pressure at which the vehicle should not be driven to avoid permanent tire damage (a deflated tire does not suffer significant damage if the vehicle is not moved). For this reason, the minimum tire pressure used by the system is significantly lower than the minimum inflation required for driving on the tires.

In other embodiments, the user interface is an electronic device separate from the system, such as a mobile phone or tablet. The independent device is preferably connected to the system wirelessly (e.g., Bluetooth^{®}), but a wired connection (e.g., USB cable) may be used. An application on the mobile device may be used to interact with the leveling system to provide operating parameters (e.g., maximum and minimum tire pressures, operating pressure) and user instructions.

A feature illustrated in one of the figures may be the same as or similar to a feature illustrated in another of the figures. Similarly, a feature described in connection with one of the figures may be the same as or similar to a feature described in connection with another of the figures. The same or similar features may be noted by the same or similar reference characters unless expressly described otherwise. Additionally, the description of a particular figure may refer to a feature not shown in the particular figure. The feature may be illustrated in and/or further described in connection with another figure.

Elements of processes (i.e., methods) described herein may be executed in one or more ways such as by a human, by a processing device, by mechanisms operating automatically or under human control, and so forth. Additionally, although various elements of a process may be depicted in the figures in a particular order, the elements of the process may be performed in one or more different orders without departing from the substance and spirit of the disclosure herein.

The foregoing description sets forth numerous specific details such as examples of specific systems, components, methods and so forth, in order to provide a good understanding of several implementations. It will be apparent to one skilled in the art, however, that at least some implementations may be practiced without these specific details. In other instances, well-known components or methods are not described in detail or are presented in simple block diagram format in order to avoid unnecessarily obscuring the present implementations. Thus, the specific details set forth above are merely exemplary. Particular implementations may vary from these exemplary details and still be contemplated to be within the scope of the present implementations.

Related elements in the examples and/or embodiments described herein may be identical, similar, or dissimilar in different examples. For the sake of brevity and clarity, related elements may not be redundantly explained. Instead, the use of the same, similar, and/or related element names and/or reference characters may cue the reader that an element with a given name and/or associated reference character may be similar to another related element with the same, similar, and/or related element name and/or reference character in an example explained elsewhere herein. Elements specific to a given example may be described regarding that particular example. A person having ordinary skill in the art will understand that a given element need not be the same and/or similar to the specific portrayal of a related element in any given figure or example in order to share features of the related element.

It is to be understood that the foregoing description is intended to be illustrative and not restrictive. Many other implementations will be apparent to those of skill in the art upon reading and understanding the above description. The scope of the present implementations should, therefore, be determined with reference to the appended claims, along with the full scope of equivalents to which such claims are entitled.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements.

Where multiples of a particular element are shown in a figure, and where it is clear that the element is duplicated throughout the figure, only one label may be provided for the element, despite multiple instances of the element being present in the figure. Accordingly, other instances in the figure of the element having identical or similar structure and/or function may not have been redundantly labeled. A person having ordinary skill in the art will recognize based on the disclosure herein redundant and/or duplicated elements of the same figure. Despite this, redundant labeling may be included where helpful in clarifying the structure of the depicted examples.

The Applicant(s) reserves the right to submit claims directed to combinations and sub-combinations of the disclosed examples that are believed to be novel and non-obvious. Examples embodied in other combinations and sub-combinations of features, functions, elements, and/or properties may be claimed through amendment of those claims or presentation of new claims in the present application or in a related application. Such amended or new claims, whether they are directed to the same example or a different example and whether they are different, broader, narrower or equal in scope to the original claims, are to be considered within the subject matter of the examples described herein. The invention has been described with reference to various specific and preferred embodiments and techniques. Nevertheless, it is understood that many variations and modifications may be made while remaining within the spirit and scope of the invention.

What is claimed is:

1. A system for leveling a vehicle, comprising:
a manifold attached to each tire of the vehicle, comprising:
a plurality of pneumatic connections to the manifold, comprising an outlet and a connection to each tire;
a plurality of tire valves, each tire valve controlling flow in a pneumatic connection between the manifold and a tire; and
an atmosphere valve controlling flow in a pneumatic connection between the manifold and the outlet;
at least one level sensor configured to detect a pitch and a roll of the vehicle; and
a processor operatively coupled to the at least one level sensor and using data from the at least one level sensor to operate the plurality of tire valves and the atmosphere valve, the processor containing non-volatile, computer-readable medium instructions to process data from the at least one level sensor and determine whether the pitch and/or roll of the vehicle are within preselected parameters, and, when the pitch and/or roll are outside the parameters, operate at least one tire valve to deflate one or more of the tires to adjust the pitch and/or roll of the vehicle.

2. The system of claim 1, wherein the manifold is adapted to attach to a source of compressed gas via an inlet valve.

3. The system of claim 2, wherein the processor is programmed to use one or more of the tire valves, the source of compressed gas, the inlet valve, and the manifold to inflate the tire.

4. The system of claim 2, wherein the manifold comprises:
an atmosphere valve to vent to ambient air; and
an inlet valve to open the tire to the source of compressed gas.

5. The system of claim 1, wherein the manifold further comprises a pressure sensor in fluid communication with the tires whereby the processor monitors the pressure in each tire.

6. The system of claim 5, wherein the processor is programmed to keep the pressure in each tire within a prescribed pressure range.

7. The system of claim 1, wherein the processor is programmed to bring a pressure in the tires to a predetermined pressure prior to the vehicle being moved again.

8. The system of claim 1, wherein the at least one level sensor comprises at least one accelerometer.

9. A method of leveling a vehicle, comprising:
providing at least one level sensor configured to detect a pitch and roll of the vehicle; providing a manifold, comprising:
a plurality of pneumatic connections to the manifold, comprising an outlet and a connection to each tire;
a plurality of tire valves, each tire valve controlling flow in a pneumatic connection between the manifold and a tire; and
an atmosphere valve controlling flow in a pneumatic connection between the manifold and the outlet;
providing a processor operatively coupled to the at least one level sensor and to operate the atmosphere valve and the plurality of tire valves, the processor containing non-volatile, computer-readable medium instructions to process data from the at least one level sensor and determine when the pitch and/or roll of the vehicle are within preselected parameters; and
when the pitch and/or roll are outside the preselected parameters, operating the at least one valve to deflate one or more of the tires to adjust the pitch and roll of the vehicle.

10. The method of claim 9, further comprising providing a source of compressed gas in fluid communication with the manifold via an inlet valve.

11. The method of claim 10, wherein the processor is programmed to use one or more of the tire valves, the source of compressed gas, the inlet valve, and the manifold to inflate one or more of the tires to adjust the pitch and/or roll of the vehicle.

12. The method of claim 10, wherein the manifold further comprises a valve to open the tire to the source of compressed gas.

13. The method of claim 9, further comprising providing a pressure sensor in fluid communication with the tire whereby the processor monitors the pressure in each of the tires.

14. The method of claim 13, wherein the processor is programmed to keep the pressure in each tire within a prescribed pressure range.

15. The method of claim 9, further comprising:
measuring the pitch and/or roll of the vehicle;
adjusting a pressure in one or more of the tires; and
repeating measuring the pitch and/or roll and adjusting the pressure until the pitch and roll of the vehicle are within the parameters.

16. The method of claim 9, wherein the processor is programmed to inflate the tires to a selected pressure for driving.

17. A system for leveling a vehicle, comprising:
at least one level sensor configured to detect a pitch and a roll of the vehicle; and
a plurality of tire inflation control devices, each comprising:
a tire valve in fluid communication with a tire and an atmosphere valve in fluid communication with the atmosphere;
a tire pressure gauge in fluid communication with the tire valve; and
a processor configured to receive data from the at least one level sensor and to control the tire valves and the atmosphere valves, the processor containing non-volatile, computer-readable medium instructions to process data from the at least one sensor and determine if the pitch and roll of the vehicle are within preselected parameters, and if the pitch and roll are outside the parameters, operate at least one valve to deflate one or more of the tires to adjust the pitch and roll of the vehicle.

18. The system of claim 17, wherein the plurality of tire inflation control devices is each adapted to attach to a source of compressed gas via an inlet valve.

19. The system of claim 18, wherein the processor is programmed to use one or more of the tire valves, the source of compressed gas, and the plurality of tire inflation control devices to inflate the tire.

20. The system of claim 18, wherein each of the plurality of tire inflation control devices comprises a valve to open the tire to the source of compressed gas.
